(19) United States
(12) Patent Application Publication
(10) Pub. No.: US 2011/0096152 A1
(43) Pub. Date: Apr. 28, 2011

(54) STEREOSCOPIC IMAGE DISPLAY

(75) Inventors: Wei-Liang Hsu, Taipei City (TW); Chi-Lin Wu, Taipei County (TW); Chou-Lin Wu, Taipei County (TW); Shin-Wen Yang, Tainan County (TW)

(73) Assignee: INDUSTRIAL TECHNOLOGY RESEARCH INSTITUTE, Hsinchu (TW)

(21) Appl. No.: 12/846,831

(22) Filed: Jul. 30, 2010

Related U.S. Application Data
(60) Provisional application No. 61/254,106, filed on Oct. 22, 2009.

(51) Int. Cl. H04N 13/04

(52) U.S. Cl. 348/51

(57) ABSTRACT

A stereoscopic image display including an image displaying unit and a directional light modulator is provided. The image displaying unit has a black matrix. The directional light modulator is disposed corresponding to the image displaying unit, wherein the directional light modulator comprises a plurality of constitutional groups repeating arranged in a first direction. Each of constitutional groups comprises a plurality of periodically changed structures, and each periodically changed structure in same constitutional group changes its size along the first direction.

### CROSS-REFERENCE TO RELATED APPLICATION

This application claims the priority benefit of U.S. provisional application No. 61/254,106, filed on Oct. 22, 2009. The entirety of the above-mentioned patent application is hereby incorporated by reference herein and made a part of this specification.

### BACKGROUND OF THE INVENTION

1. Technical Field

The present invention relates to a display apparatus, and more particularly to a stereoscopic image display.

2. Background

In recent years, continuous advancement of display technologies results in increasing demands on display quality of displays, such as image resolution, color saturation, and so on. Nevertheless, in process of purchasing a display, whether the display is able to display 3D images or not is also taken into consideration in addition to high image resolution and high color saturation.

Typically, there are many types of technologies for forming a 3D image, such as the holographic type technology, the multi-plane technology and the parallax-image technology. Since the holographic type technology and the multi-plane technology have the difficulty of handling huge amount of data and the poor display result, the parallax-image technology becomes the current major stereo image formation technology. The parallax-image technology uses the spatial-multiplexed three-dimensional display technology as the major application technology. In the spatial-multiplexed three-dimensional display technology, the lenticular screen or the parallax barrier is used to form the viewing zones for the right eye and the left eye of the viewer in order to establish the stereo image effect.

In detail, according to visual characteristics of human eyes, a 3D image may be produced when two images with the same content but different parallax are respectively captured by a viewer's left and right eyes.

In current 3D image display technologies, a spatial-multiplexed technology is mainly utilized for controlling images captured in respective eyes of a viewer. The means being used in the spatial-multiplexed technology, such as the lenticular screen or the parallax barrier, has been disclosed in several prior art references. For example, U.S. Pat. No. 6,064,424 has disclosed a spatial-multiplexed technology by means of a lenticular screen; U.S. Pat. No. 7,268,943 has disclosed a spatial-multiplexed technology by means of a parallax barrier. No matter what means is used in stereoscopic image display, a problem of moiré is always existed in the stereoscopic image display of related art, wherein the moiré phenomenon is shown as FIG. 1.

To resolve said issue, several prior art reference has disclosed some proposed method for modifying the parallax barrier or lenticular screen, such as U.S. Pat. No. 7,317,494, U.S. patent Nos. 20080316379, and 20080079662. However, these methods disclosed in the above prior references have disadvantages of high production cost, hard to be fabricated and high crosstalk.

### SUMMARY

A stereoscopic image display including an image displaying unit and a directional light modulator is provided. The image displaying unit has a pixel array. The directional light modulator is disposed corresponding to the image displaying unit, wherein the directional light modulator comprises a plurality of constitutional groups repeating arranged in a first direction. Each of constitutional groups comprises a plurality of periodically changed structures, and each periodically changed structure in same constitutional group changes its size along the first direction.

Several exemplary embodiments accompanied with figures are described in detail below to further describe the disclosure in details.

### BRIEF DESCRIPTION OF THE DRAWINGS

The accompanying drawings constituting a part of this specification are incorporated herein to provide a further understanding of the invention. Here, the drawings illustrate embodiments of the invention and, together with the description, serve to explain the principles of the invention.

FIG. 1 is a schematic morie phenomenon of a conventional stereoscopic image display.

FIGS. 2A and 2B are schematic front views of stereoscopic image display according to the first embodiment of the present invention.

FIG. 3A is a schematic front view of an directional light modulator in the stereoscopic image display according to the first embodiment of the present invention.

FIG. 3B is a schematic cross-sectional view along lines BB of FIG. 3A of a stereoscopic image display according to the first embodiment of the present invention.

FIG. 3C is another schematic front view of an directional light modulator in the stereoscopic image display according to the first embodiment of the present invention, wherein the slits of the patterns intersect with the data line of the image display unit in an included angle.

FIG. 4 illustrates a relationship between a width and a position of periodically changed structures in a constitutional group of FIG. 3B of a stereoscopic image display according to the first embodiment of the present invention.

FIG. 5A is a schematic cross-sectional view of an directional light modulator in a stereoscopic image display according to the first embodiment of the present invention.

FIG. 5B illustrates a relationship between a width and a position of periodically changed structures in a constitutional group of FIG. 5A of a stereoscopic image display according to the first embodiment of the present invention.

FIG. 6A is a schematic cross-sectional view of an directional light modulator in another stereoscopic image display according to the first embodiment of the present invention.

FIG. 6B illustrates a relationship between a width and a position of periodically changed structures in a constitutional group of FIG. 6A of a stereoscopic image display according to the first embodiment of the present invention.

FIG. 7 is an explanatory view showing the principle of a stereoscopic image display which allows viewers to view in different viewing positions.

FIG. 8A is an explanatory view showing the relationship between an array of pixels of the image displaying unit and a slit on the conventional parallax barrier in different viewing positions.

FIG. 8B is an explanatory view showing the relationship between an array of pixels of the image displaying unit and a slit on the directional light modulator illustrating in the preceding embodiments in different viewing positions.

FIG. 9 is a schematic front view of a directional light modulator in the stereoscopic image display according to the second embodiment of the present invention.

FIG. 10A is a schematic cross-sectional view along lines AA of FIG. 9 of a stereoscopic image display according to the second embodiment of the present invention.

FIG. 10B illustrates a relationship between a pitch and a position of slits in a constitutional group of FIG. 10A of a stereoscopic image display according to the second embodiment of the present invention.

FIG. 11 is a schematic view of a directional light modulator in the stereoscopic image display according to the third embodiment of the present invention.

FIG. 12A is a schematic cross-sectional view along lines AA of directional light modulator shown in FIG. 11 according to the third embodiment of the present invention.

FIG. 12B illustrates a relationship between a width and a position of periodically changed structures in a constitutional group of FIG. 12A of a stereoscopic image display according to the third embodiment of the present invention.

FIG. 13 is a schematic view of a directional light modulator in the stereoscopic image display according to the fourth embodiment of the present invention.

FIG. 14A is a schematic cross-sectional view along lines XX of directional light modulator shown in FIG. 13 according to the fourth embodiment of the present invention.

FIG. 14B illustrates a relationship between a width and a position along X direction of periodically changed structures in a constitutional group of FIG. 14A of a stereoscopic image display according to the fourth embodiment of the present invention.

FIG. 15A is a schematic cross-sectional view along lines YY of directional light modulator shown in FIG. 13 according to the forth embodiment of the present invention.

FIG. 15B illustrates a relationship between a width and a position along Y direction of periodically changed structures in a constitutional group of FIG. 15A of a stereoscopic image display according to the fourth embodiment of the present invention.

FIG. 16 is a schematic view of another directional light modulator in the stereoscopic image display according to the fourth embodiment of the present invention.

FIG. 17A is a schematic cross-sectional view along lines XX of directional light modulator shown in FIG. 16 according to the fourth embodiment of the present invention.

FIG. 17B illustrates a relationship between a width and a position along X direction of periodically changed structures in a sub-constitutional group of FIG. 17A of a stereoscopic image display according to the fourth embodiment of the present invention.

FIG. 18 is a schematic view of a directional light modulator in the stereoscopic image display according to the fifth embodiment of the present invention.

FIG. 19A is a schematic cross-sectional view along lines XX of directional light modulator shown in FIG. 18 according to the fifth embodiment of the present invention.

FIG. 19B illustrates a relationship between a width and a position along X direction of periodically changed structures in a constitutional group of FIG. 19A of a stereoscopic image display according to the fifth embodiment of the present invention.

FIG. 20A is a schematic cross-sectional view along lines YY of directional light modulator shown in FIG. 18 according to the fifth embodiment of the present invention.

FIG. 20B illustrates a relationship between a width and a position along Y direction of periodically changed structures in a constitutional group of FIG. 20A of a stereoscopic image display according to the fifth embodiment of the present invention.

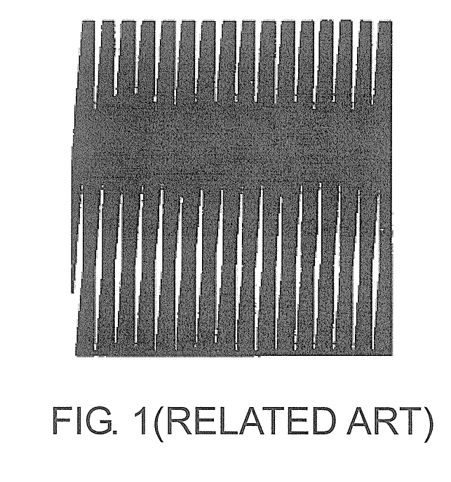

### DETAILED DESCRIPTION OF DISCLOSED EMBODIMENTS

In the present invention, a new stereoscopic image display technique is accomplished by equipping a directional light modulator with periodically changed structures, so as to reduce the morie phenomenon and provide excellent stereo image quality. The directional light modulator may be parallax barrier, refrarctional device or diffrative optical device, wherein the refrarctional device may be constructed by lenticular lens or lens array. Embodiments of the present invention will be described below. However, these embodiments are not intended for limiting the scope of the invention. Besides, some of the embodiments may be combined appropriately to produce other different embodiments of the present invention.

### First Embodiment

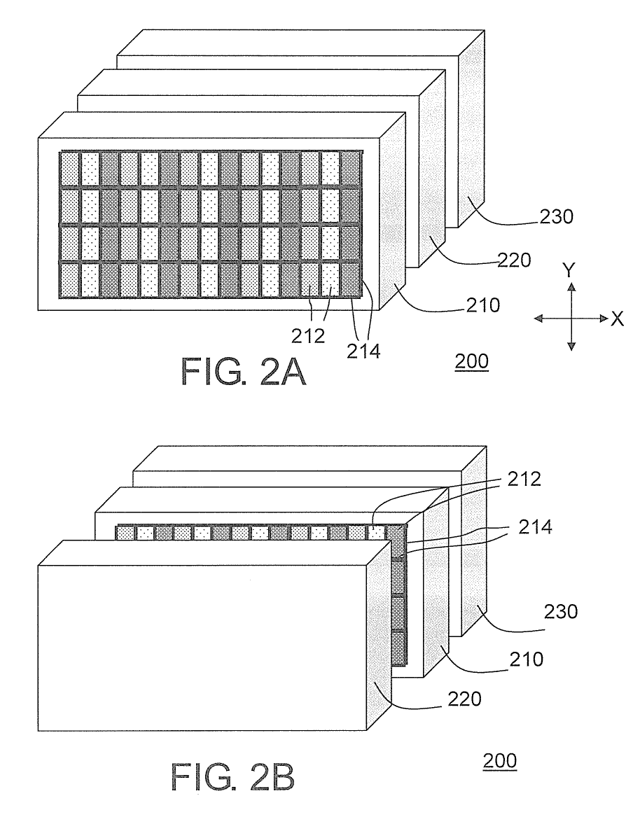

FIGS. 2A and 2B are schematic front views of stereoscopic image display according to the first embodiment of the present invention. Referring to FIG. 2A, a stereoscopic image display 200 of the present embodiment includes an image displaying unit 210 and a directional light modulator 220. In this embodiment, stereoscopic image display 200 may further include backlight module 230, wherein the image displaying unit 210 is a liquid crystal display panel, for example. The image displaying unit 210 a plurality of scan lines (not show), a plurality of data lines (not show) and a plurality of pixels 212 arranged in an array in the display region for displaying an image, wherein the pixels 212 are defined by the scan lines disposed along the X direction interlacing the data lines disposed along the Y direction so as to form a pixel array. In this case, the position of the scan lines and the data lines are corresponding to the position of the black matrix 214. In other words, the black matrix is arranged along X direction and the Y direction of the image displaying unit 210 in the present embodiment, which also defines the pixel array. It is noted that a column direction of the pixel array or the black matrix 214 in the present embodiment is substantially parallel to the Y direction and a row direction of the pixel array or the black matrix 214 in the present embodiment is substantially parallel to the X direction.

Certainly, the image displaying unit 210 may be an organic light emitting diode display, the present invention is not limited the types of image displaying unit 210. As shown in FIG. 2A, the directional light modulator 220 is disposed between the image displaying unit 210 and the backlight module 230. On the other hand, referring to FIG. 2B, the image displaying unit 210 may also dispose between the directional light modulator 220 and the backlight module 230. Specially, the directional light modulator 220 is able to reduce the brightness variation while viewer changes his viewing position. As such, the viewer may not sense the variation of brightness even when the person changes his viewing position, and thus the viewer would not sense morie.

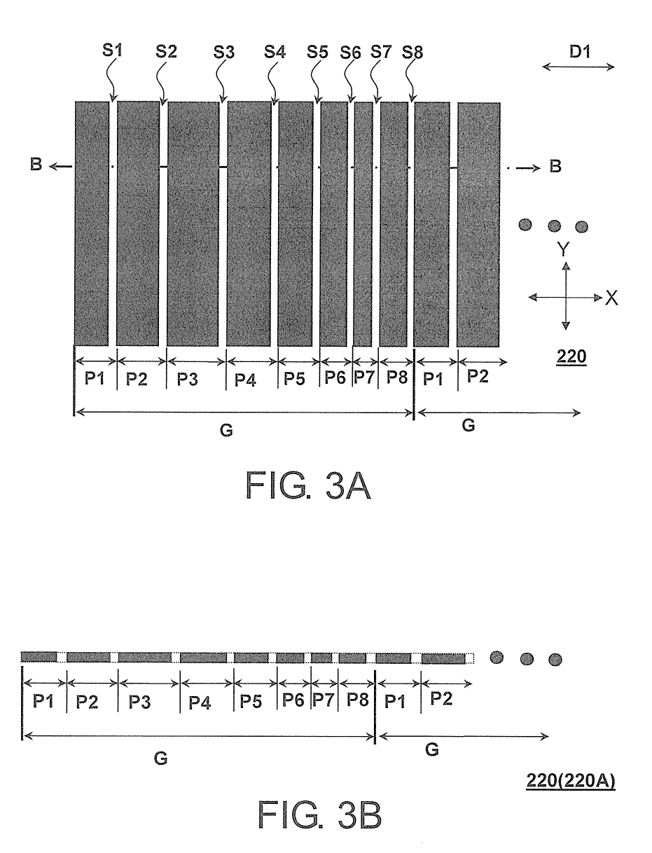

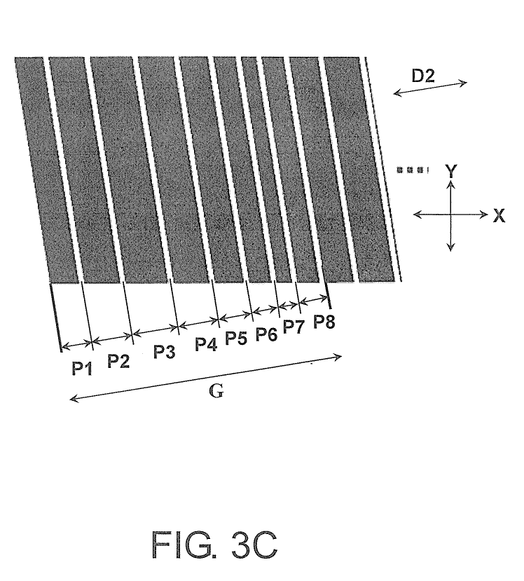

More specifically, FIG. 3A is a schematic front view of a directional light modulator in the stereoscopic image display according to the first embodiment of the present invention, and FIG. 3B is a schematic cross-sectional view along lines BB of FIG. 3A of a stereoscopic image display according to the first embodiment of the present invention. Referring to FIGS. 3A and 3B, the directional light modulator 220 includes a plurality of constitutional groups G repeating arranged in a first direction, such as horizontal direction. Herein, the first direction is named as a repeating direction D1. Each of constitutional groups G includes a plurality of periodically changed structures P, such as pattern P1 to P8, which means each pattern P1 to P8 in each constitutional group G may periodically changing its size along the repeating direction D1 of the constitutional groups G. In other words, the directional light modulator 220 in the present embodiment has multi-width periodically changed structures P1 to P8, for example.

In the present embodiment, the constitutional group G as shown in FIG. 3A and FIG. 3B is taken as an example to describe. As shown in FIG. 3A and FIG. 3B, each constitutional group G includes the periodically changed structures, i.e. patterns P1 to P8, wherein the widths of patterns P1 to P8 are varied with the positions. In detail, the widths from pattern P1 to pattern P3 are gradually increased, the widths from pattern P3 to pattern P7 are gradually decreased, and the widths from pattern P7 to pattern P8 are gradually increased. Hence, the widths of the patterns P1 to P8 in the same constitutional group G are periodically changing in the present embodiment, and the next constitutional group G having the same patterns P1 to P8 is disposed adjacent thereto, such that the repeating constitutional groups G constitute the directional light modulator 220. As shown in FIG. 3A and FIG. 3B, the periodically changed structures are parallax barriers, for example and the black portion has light-shielding function. In addition, each pattern P1 to P8 respectively has a slit S1 to S8 adjacent to the neighboring pattern, and the extending direction of the slits S1 to S8 are parallel to the data lines of image displaying unit 210 in this embodiment. The slits S1 to S8 are suitable for splitting an image into a right-eye frame and a left-eye frame, and the pitches of the slits S1 to S8 within the same constitutional group G are substantially the same in the present embodiment.

It should be noted that in the above-mentioned embodiment, the repeating direction D1 of the constitutional groups G and the plurality of periodically changed structures P are substantially along the horizontal direction, such that the length extending direction of slit S1 to S8 of the pattern P1 to P8 are substantially along the direction of the data lines arranged on the image displaying unit 210, in other words, the length extending direction of each slit S1 to S8 is parallel to the column direction or the row direction of the black matrix. Certainly, the slit S1 to S8 of the pattern P1 to P8 may also be arranged along a direction which is not parallel to the direction of the data lines of the image displaying unit 210, as shown in FIG. 3C. Referring to FIG. 3C, a length extending direction of each slit S1 to S8 and a direction of the data lines of the image displaying have an included angle, wherein the included angle is not equal to zero. That is, the length extending direction of each slit S1 to S8 is not parallel to the column direction of the black matrix, and the black portion of each pattern P1 to P8 has an extending direction parallel to the silts S1 to S8. As such, the resolution in the horizontal direction of the three-dimensional images display by the stereoscopic image display is substantially maintained. That is, compare to the stereoscopic image display shown in FIG. 3A, the stereoscopic image display shown in FIG. 3C has higher resolution in the horizontal direction.

For better illustration the periodically changing of the patterns in the same constitutional group G, some periodical functions are taken as examples to describe the relationship between the widths of the periodically changed structures P1 to P8 in the same constitutional group G, but the embodiments in the follows are not limit the present invention.

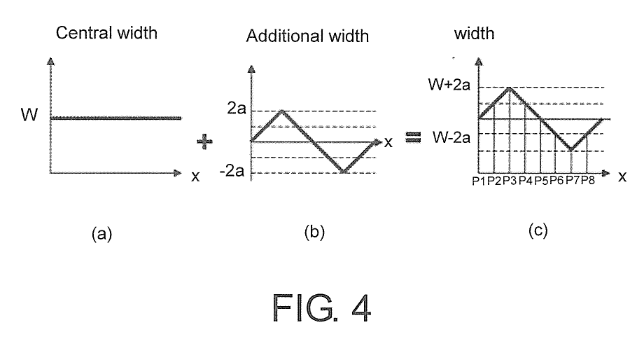

FIG. 4 illustrates a relationship between a width and a position of periodically changed structures in a constitutional group of FIG. 3B of a stereoscopic image display according to the first embodiment of the present invention, wherein the directional light modulator shown in FIG. 3B is 220A. Referring to FIG. 4, in the directional light modulator 220A of this embodiment, take the width of the pattern P1 and that of the pattern P5 as central width W as shown in (a) of FIG. 4, and a width of each pattern related to the central width W in same constitutional group G is defined as an additional width as shown in (b) of FIG. 4. The amplitude of width vibration within the same constitutional group G is 2a, and the cycle within the same constitutional group ranges from pattern P1 to pattern P8. As shown in (b) and (c) of FIG. 4, the widths of the periodically changed structures P1 to P8 in the same constitutional group G along the positions satisfy a function of triangle wave.

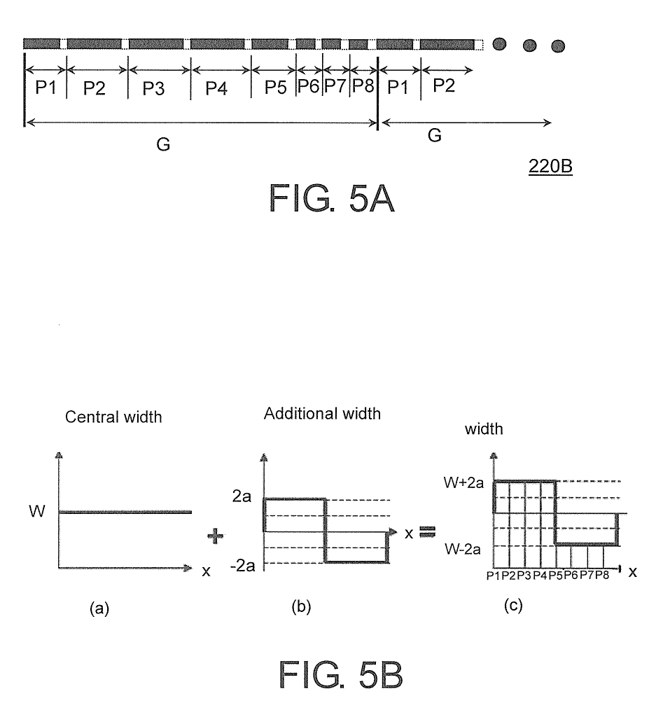

FIG. 5A is a schematic cross-sectional view of a directional light modulator in a stereoscopic image display according to the first embodiment of the present invention, and FIG. 5B illustrates a relationship between a width and a position of periodically changed structures in a constitutional group of FIG. 5A of a stereoscopic image display according to the first embodiment of the present invention. Referring to FIG. 5A and FIG. 5B, in the directional light modulator 220B of this embodiment, take the width of the pattern P1 and that of the pattern P5 as central width Was shown in (a) of FIG. 5B, and a width of each pattern related to the central width in same constitutional group G is defined as an additional width as shown in (b) of FIG. 5B. The amplitude of width vibration within the same constitutional group G is 2a, and the cycle within the same constitutional group ranges from pattern P1 to pattern P8. As shown in (b) and (c) of FIG. 5B, the widths of the periodically changed structures P1 to P8 in one constitutional group G along the positions satisfy a function of square wave. It should be noted that the central width W is not limited to the width of the pattern P1 or P5, in other embodiment, the width of the pattern P1 to P8 may be W+2a, W+2a, W+2a, W+2a, W−2a, W−2a, W−2a, W−2a, respectively. FIGS. 5A and 5B merely exemplify a relationship between a width and a position of periodically changed structures in a constitutional group.

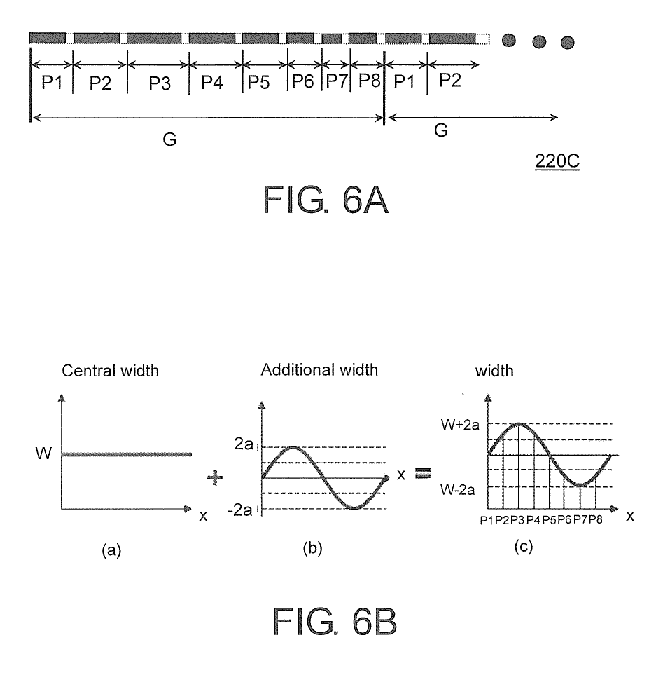

FIG. 6A is a schematic cross-sectional view of a directional light modulator in another stereoscopic image display according to the first embodiment of the present invention, and FIG. 6B illustrates a relationship between a width and a position of periodically changed structures in a constitutional group of FIG. 6A of a stereoscopic image display according to the first embodiment of the present invention. Referring to FIG. 6A and FIG. 6B, in the directional light modulator 220C of this embodiment, take the width of the pattern P1 and that of the pattern P5 as central width W as shown in (a) of FIG. 6B, and a width of each pattern related to central width W in same constitutional group G is defined as an additional width as shown in (b) of FIG. 6B. The amplitude of width vibration within the same constitutional group G is 2a, and the cycle within the same constitutional group ranges from pattern P1 to pattern P8. As shown in (b) and (c) of FIG. 6B, the widths of the periodically changed structures P in one constitutional group G along the positions satisfy a function of sine wave.

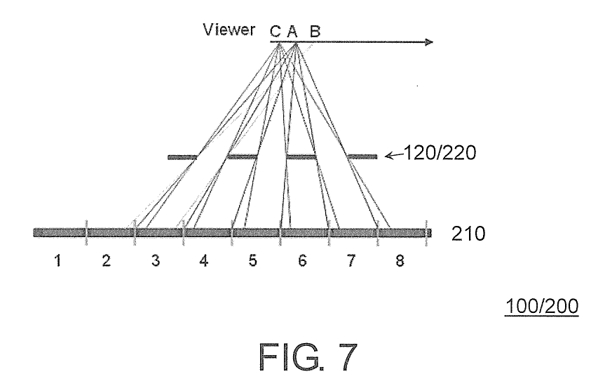

For better illustration, the stereoscopic image display 200 as shown in FIG. 7 is taken as an example to describe the following embodiments, but the embodiments in the follows are not limit the present invention.

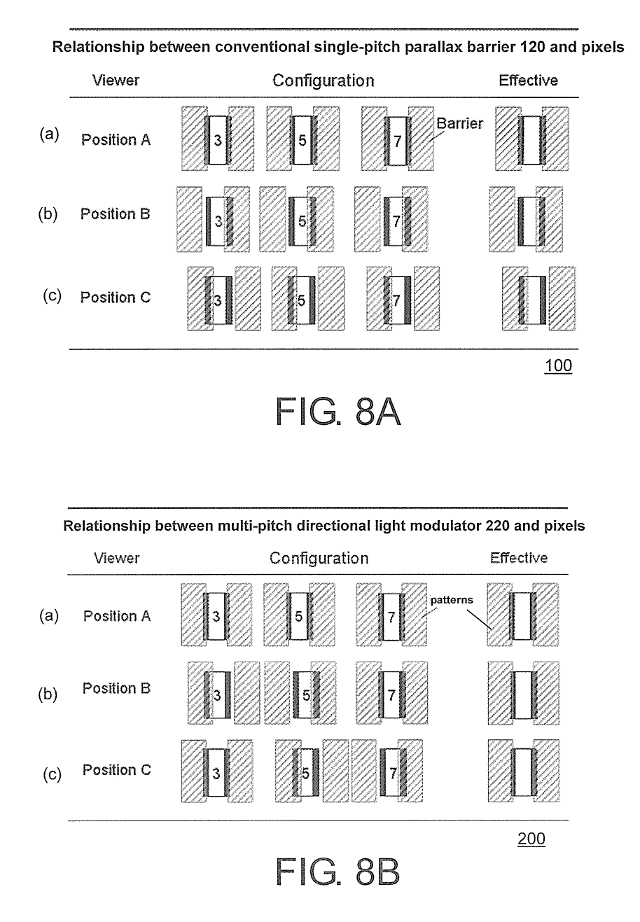

FIG. 7 is an explanatory view showing the principle of a stereoscopic image display which allows viewers to view in different viewing positions, wherein the directional light modulator shown in FIG. 7 may signify the conventional parallax barrier 120 or the directional light modulator illustrating in the preceding embodiments 220. FIG. 8A is an explanatory view showing the relationship between an array of pixels of the image displaying unit and a slit on the conventional parallax barrier 120 in different viewing positions, and FIG. 8B is an explanatory view showing the relationship between an array of pixels of the image displaying unit and a slit on the directional light modulator 220 illustrating in the preceding embodiments in different viewing positions, herein, the directional light modulator 220 is a parallax barrier with periodically changed structures in this embodiment.

Referring to FIG. 7 and FIG. 8A, since the conventional parallax barrier 120 of the conventional stereoscopic image display 100 is a single-pitch parallax barrier, the morie phenomenon is easily produced while the viewer changes his viewing positions, such as position A, position B and position C shown in FIG. 7. When the viewer views stereoscopic image display 100 at viewing position A, the light from pixels 3, 5, 7 is given to the eyes of the viewer through the corresponding slits of the parallax barrier, and a state where light from the whole pixels is given as shown in (a) of FIG. 8A, which the total effective viewing frame is normal without shift. When the viewer views the stereoscopic image display 100 at viewing position B, the light from pixels 3, 5, 7 given to the eyes of the viewer through the corresponding slits of the parallax barrier is right-shift opposite to the corresponding slits, and a state where light from the whole pixels is given as shown in (b) FIG. 8A, which the total effective viewing frame is right-shift. As such, the viewer could not view the whole image displayed by the image display unit and also view a dark region due to a portion of black matrix on the left side of the pixels 3, 5, 7. Accordingly, the coexistence of the bright region displayed by pixels 3, 5, 7 and the dark region of black matrix on the left side of the pixels 3, 5, 7 makes the viewer to feel moiré. Likewise, when the viewer views the stereoscopic image display 100 at viewing position C, the light from pixels 3, 5, 7 given to the eyes of the viewer through the corresponding slits of the parallax barrier is left-shift opposite to the corresponding slits, and a state where light from the whole pixels is given as shown in (c) FIG. 8A, which shows the total effective viewing frame being left-shift. As such, the viewer could not view the whole image displayed by the image display unit and also view a dark region due to a portion of black matrix on the right side of the pixels 3, 5, 7. Accordingly, the coexistence of the bright region displayed by pixels 3, 5, 7 and the dark region of black matrix on the right side of the pixels 3, 5, 7 makes the viewer to feel moiré.

On the other hand, referring to FIG. 7 and FIG. 8B, since directional light modulator 220 of the stereoscopic image display 200 in the present invention has multiple-pitch patterns, the morie phenomenon can be effectively reduced while the viewer changes his viewing positions, such as position A, position B and position C shown in FIG. 7. As the forementioned description, a state where light from the whole pixels is given as shown in (a) of FIG. 8A when the viewer views the stereoscopic image display 200 at viewing position A, and the total effective viewing frame is normal without shift. Moreover, when the viewer views the stereoscopic image display 200 at viewing position B, although the light from pixels 3, 5, 7 each given to the eyes of the viewer through the corresponding slits of the parallax barrier is shifted opposite to the corresponding slits, the total effective viewing frame keeps normal due to the widths of the patterns in the constitutional group G are periodically changed. More specifically, the light from pixel 3 given to the eyes of the viewer through the corresponding slits of the parallax barrier is left-shift opposite to the corresponding slits, the light from pixel 5 given to the eyes of the viewer through the corresponding slits of the parallax barrier is right-shift opposite to the corresponding slits, and the light from pixel 7 given to the eyes of the viewer through the corresponding slits of the parallax barrier is substantially not shifted. By this way, the light from pixels 3, 5, 7 given to the eyes of the viewer through the corresponding slits of the parallax barrier are compensated from each other, so that the total effective viewing frame is normal without shift. Consequently, since the bright region displayed by pixels 3, 5, 7 and the dark region due to the black matrix of shifted pixels are blurred, the moiré phenomenon can be effectively reduced. In the same manner, when the viewer views the stereoscopic image display 200 at viewing position C, although the light from pixels 3, 5, 7 each given to the eyes of the viewer through the corresponding slits of the parallax barrier is shifted opposite to the corresponding slits, the total effective viewing frame keeps normal due to the widths of the patterns in the constitutional group G are periodically changed. For the same reason, the light from pixels 3, 5, 7 each given to the eyes of the viewer through the corresponding slits of the parallax barrier is respectively substantially not shifted, left-shift, and right-shift in sequence, which are compensated to each other, so that the total effective viewing frame is normal without shift. Accordingly, since the bright region displayed by pixels 3, 5, 7 and the dark region due to the black matrix of shifted pixels are blurred, the moiré phenomenon can be effectively reduced.

### Second Embodiment

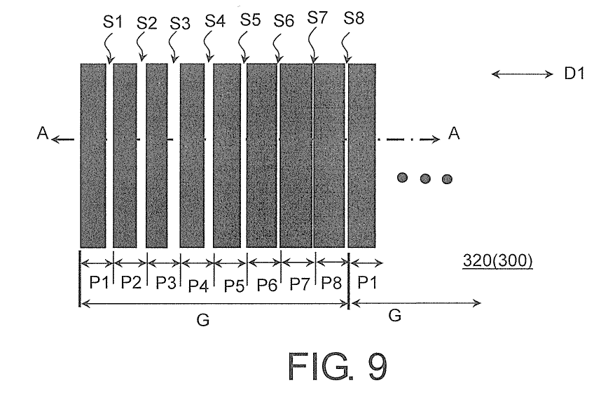

FIG. 9 is a schematic front view of a directional light modulator in the stereoscopic image display according to the second embodiment of the present invention, wherein the stereoscopic image display 300 in second embodiment is similar to the stereoscopic image display 200 in the first embodiment except the periodically changed structures in each constitutional group G of the directional light modulator 320 are periodically changing the slit pitch therein. In other words, the periodically changed structures in same constitutional group in this embodiment are slits S1 to S8, wherein each periodically changed structure, i.e. slits S1 to S8, changes its size along the first direction. As such, the directional light modulator 220 in the present invention has multi-pitch periodically changed pattern.

More specifically, each constitutional group G comprises a plurality of patterns P1 to P8, and each pattern has a corresponding slit S1 to S8. The width W of each pattern P1 to P8 in each constitutional group G is fixed, but the slit pitch of each pattern P1 to P8 is periodically changed along the repeating direction D1 of the constitutional groups G in the present embodiment. The constitutional group G as shown in FIG. 9 is taken as an example to describe. Referring to FIG. 9, the constitutional group G includes patterns P1 to P8, wherein the widths of patterns P1 to pattern P8 are fixed as W. It should be noted that each pattern P1 to P8 has a slit, and the pitches of the slits in patterns P1-P8 are varied with the positions. In other words, the slits S1 to S8 of patterns P1 to P8 in the same constitutional group G are periodically changed structures in this embodiment. As shown in FIG. 9, the pitches from the slit S1 to the slit S3 are gradually increased, the pitches from the slit S3 to the slit S7 are gradually decreased, and pitches from the slit S7 to the slit S8 are gradually increased. Hence, the pitches of the slits S1 to S8 of the patterns P1 to P8 in the same constitutional group G are periodically changing in the present embodiment. In addition, the next constitutional group G including the same patterns P1 to P8 having slit S1 to S8 arranged in the same manner is disposed adjacent thereto. In practice, the viewer views the image displayed by the image displaying unit 210 (shown in FIG. 2A and FIG. 2B) through the slits S1 to S8 of the directional light modulator 320. As a result, the displayed image is split into a right-eye frame and a left-eye frame, and thus establishes a stereo image effect.

Furthermore, in consideration of improving the resolution in the horizontal direction, the repeating direction of the constitutional groups G and the plurality of periodically changed structures P may also arranged as the stereoscopic image display as shown in FIG. 3C.

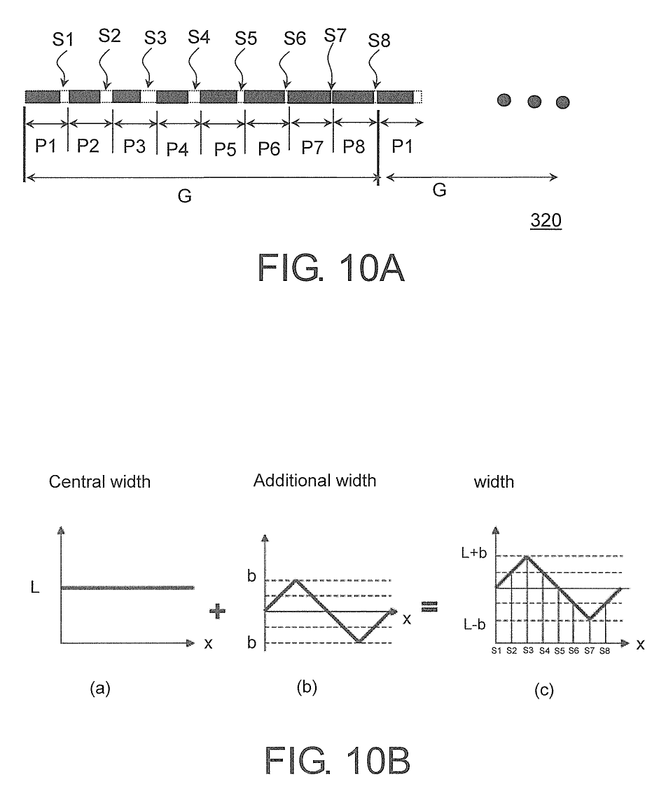

FIG. 10A is a schematic cross-sectional view along lines AA of FIG. 9 of a stereoscopic image display according to the second embodiment of the present invention. FIG. 10B illustrates a relationship between a pitch and a position of slits in a constitutional group of FIG. 10A of a stereoscopic image display according to the second embodiment of the present invention. Referring to FIG. 10B, in the directional light modulator 320 of this embodiment, take the pitch of the slit S1 and that of the slit S5 as central pitch L as shown in (a) of FIG. 10B, and a pitch of each slit S1 to S8 related to the central pitch L in same constitutional group G is defined as an additional pitch as shown in (b) of FIG. 10B. The amplitude of slit pitch vibration within the same constitutional group G is b, and the cycle within the same constitutional group ranges from pattern P1 to pattern P8. As shown in (b) and (c) of FIG. 10B, the pitches of the slit S1 to S8 corresponding to the patterns P1 to P8 in one constitutional group G along the positions satisfy a function of triangle wave, for example. It should be notice that the slit pitches of the periodically changed structures P1 to P8 in one constitutional group G along the positions may also satisfy other periodical function as mentioned in the first embodiment, such as square wave, sine wave, other trigonometric waves, or other proper periodical function, and thus not reiterated herein.

Moreover, the stereoscopic image display 300 of the present embodiment also can provide an excellent stereo image for viewers viewing in different viewing positions. Referring to the preceding interpretation in the first embodiment as shown in FIG. 7 and FIG. 8B, when the viewer views the stereoscopic image display 300 at different viewing positions, the bright region displayed by pixels and the dark region due to the black matrix of shifted pixels are blurred, the total effective viewing frame keeps normal due to the slit pitches of the patterns in the constitutional group G are periodically changed, such that the moiré phenomenon can be effectively reduced and thus providing an excellent stereo image for viewers.

### Third Embodiment

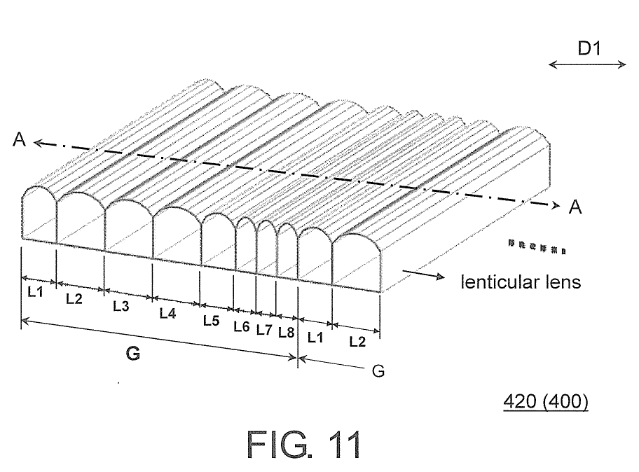

FIG. 11 is a schematic view of a directional light modulator in the stereoscopic image display according to the third embodiment of the present invention, wherein the principle of the stereoscopic image display 400 in third embodiment is similar to the stereoscopic image display 200, 300 in the aforementioned embodiments except the directional light modulator 420 is a lenticular screen. More specifically, the directional light modulator 420 in this embodiment is a lenticular lens arranged along the repeating direction D1, wherein the lenticular lens array has a plurality of constitutional groups G repeating arranged in horizontal direction, wherein each of constitutional groups G includes a plurality of periodically changed structures, such as lenticular lens L1 to L8. Each of the periodically lenticular lenses L1 to L8 in each constitutional group G may periodically changing its size along the repeating direction D1 of the constitutional groups G. In other words, the directional light modulator 420 in the present invention has multi-width periodically changed lenticular lenses.

Furthermore, in consideration of improving the resolution in the horizontal direction, the repeating direction of the constitutional groups G and the plurality of periodically changed lenticular lens may also arranged as the stereoscopic image display as shown in FIG. 3C.

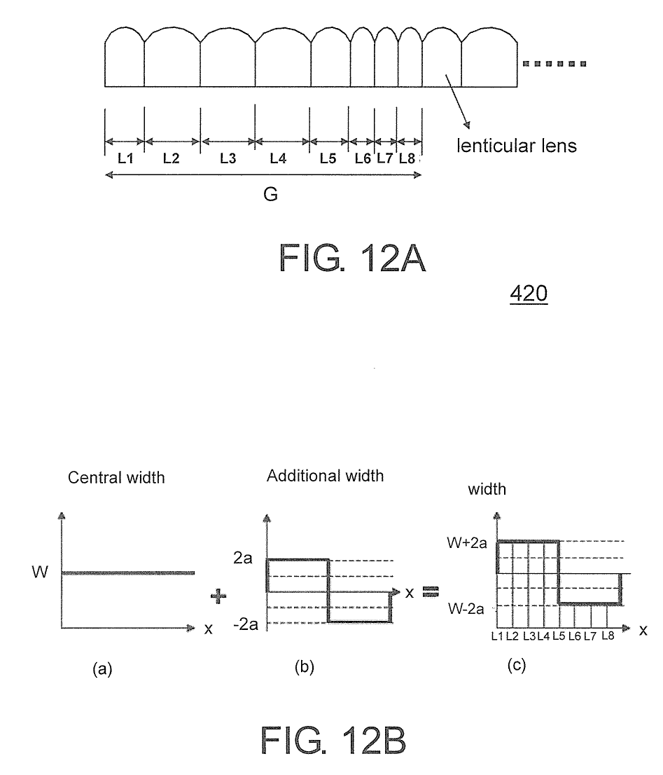

FIG. 12A is a schematic cross-sectional view along lines AA of directional light modulator shown in FIG. 11 according to the third embodiment of the present invention, and FIG. 12B illustrates a relationship between a width and a position of periodically changed structures in a constitutional group of FIG. 12A of a stereoscopic image display according to the third embodiment of the present invention. Referring to FIGS. 12A and 12B, in the directional light modulator 420 of this embodiment, take the width of the lens L1 and that of the lens L5 as central width W as shown in (a) of FIG. 12B, and a width of each lens related to the central width W in same constitutional group G is defined as an additional width as shown in (b) of FIG. 12B. The amplitude of width vibration of lenses within the same constitutional group G is substantially 2a, and the cycle within the same constitutional group ranges from lens L1 to lens L8. As shown in (b) and (c) of FIG. 12B, the widths of the lenses L1 to L8 in one constitutional group G along the positions satisfy a function of square wave. Of course, the widths of the periodically changed structures, i.e. lenticular lenses L1 to L8, in one constitutional group G along the positions may satisfy other periodically functions like triangle wave or sine wave as mentioned in the foregoing embodiments.

In the present embodiment, since directional light modulator of the present invention has multiple-width periodically changed lenticular lenses, the morie phenomenon can be effectively reduced while the viewer changes his viewing position, the principle is similar to the first embodiment and the second embodiment and thus not reiterated herein. It should be noted that since the periodically changed lenticular lenses are periodically changing their widths, the bright region displayed by pixels and the dark region due to the black matrix of shifted pixels could be blurred. As a result, the total effective viewing frame keeps normal due to the widths of the lenticular lenses in the constitutional group G are periodically changed, so as to reduce the moiré phenomenon and thus providing an excellent stereo image for viewers.

### Fourth Embodiment

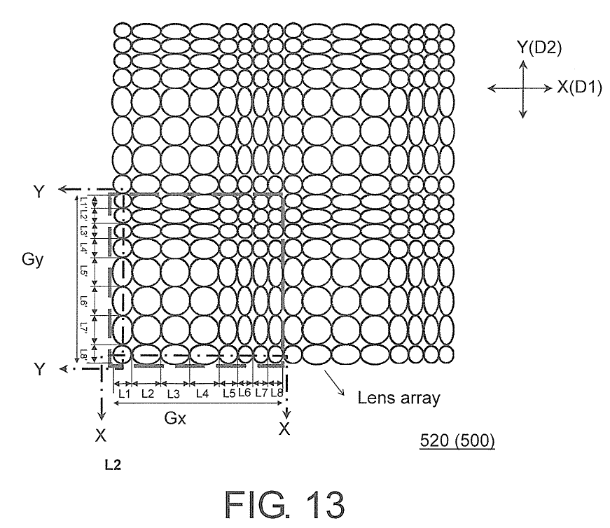

FIG. 13 is a schematic view of a directional light modulator in the stereoscopic image display according to the fourth embodiment of the present invention, wherein the principle of the stereoscopic image display 500 in fourth embodiment is similar to the stereoscopic image display 200, 300, 400 in the aforementioned embodiments except the directional light modulator 520 is a lens array. More specifically, the directional light modulator 520 in this embodiment is a lens array, wherein the lens array has a plurality of constitutional groups G repeating arranged in the first direction and the second direction respectively. Herein, the first direction and the second direction are named as X and Y directions respectively. Each of constitutional groups G includes a plurality of periodically changed lenses arranged in an array as the periodically changed pattern. More specifically, each of the periodically lenses in one constitutional group G arranged in X direction is defined as a sub-constitutional group Gx including periodically changed lenses L1 to L8, and each of the periodically lenses in the same constitutional group G arranged in Y direction is defined as a sub-constitutional group Gy including periodically changed lenses L1′ to L8′. As shown in FIG. 13, the periodically lenses either in sub-constitutional groups Gx or sub-constitutional groups Gy may periodically changing its width along the X direction or Y direction of the constitutional groups G. In other words, the directional light modulator 520 in the present invention has multi-width periodically changed lenses arranged in an array.

Furthermore, in consideration of improving the resolution in the horizontal direction, the repeating direction of the sub-constitutional groups Gx and periodically changed lenses L1 to L8 may also arranged as the stereoscopic image display as shown in FIG. 3C. On the other hand, the repeating direction of the sub-constitutional groups Gy and periodically changed lenses L1′ to L8′ therein may also arranged as the stereoscopic image display as shown in FIG. 3C, so as to improve the resolution in the vertical direction.

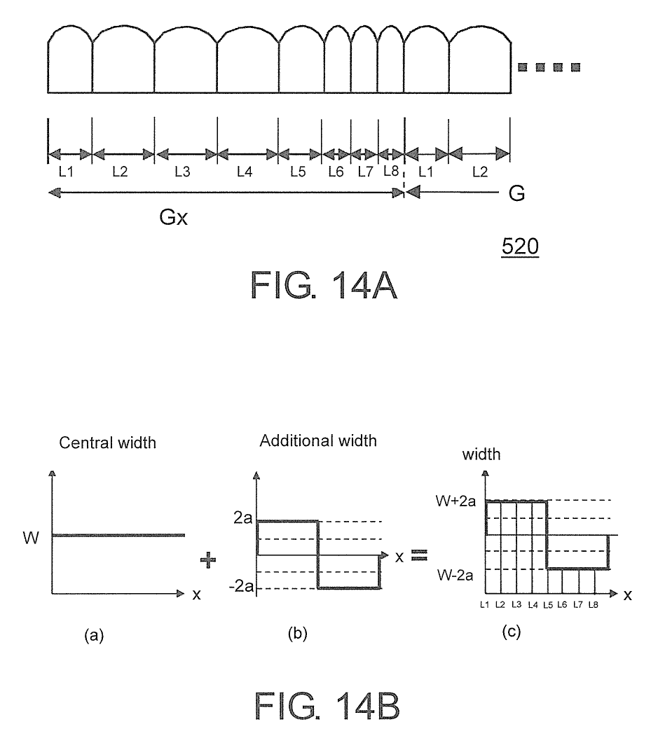

FIG. 14A is a schematic cross-sectional view along lines XX of directional light modulator shown in FIG. 13 according to the fourth embodiment of the present invention, and FIG. 14B illustrates a relationship between a width and a position along X direction of periodically changed structures in a constitutional group of FIG. 14A of a stereoscopic image display according to the fourth embodiment of the present invention. Referring to FIGS. 14A and 14B, in the directional light modulator 520 of this embodiment, take the width of the lens L1 and that of the lens L5 as central width W as shown in (a) of FIG. 14B, and a width of each lens related to the central width W in same sub-constitutional group Gx is defined as an additional width as shown in (b) of FIG. 14B. The amplitude of width vibration of lenses within the same constitutional group G is substantially 2a, and the cycle within the same sub-constitutional group ranges from lens L1 to L8. As shown in (b) and (c) of FIG. 14B, the widths of the periodically changed structures, i.e. lenses, L1 to L8 in one sub-constitutional group Gx along the X direction satisfy a function of square wave. Of course, the widths of the periodically changed structures, which are lenses arranged in array of one sub-constitutional group Gx along X direction may satisfy other periodically functions like triangle wave or sine wave as mentioned in the foregoing embodiments.

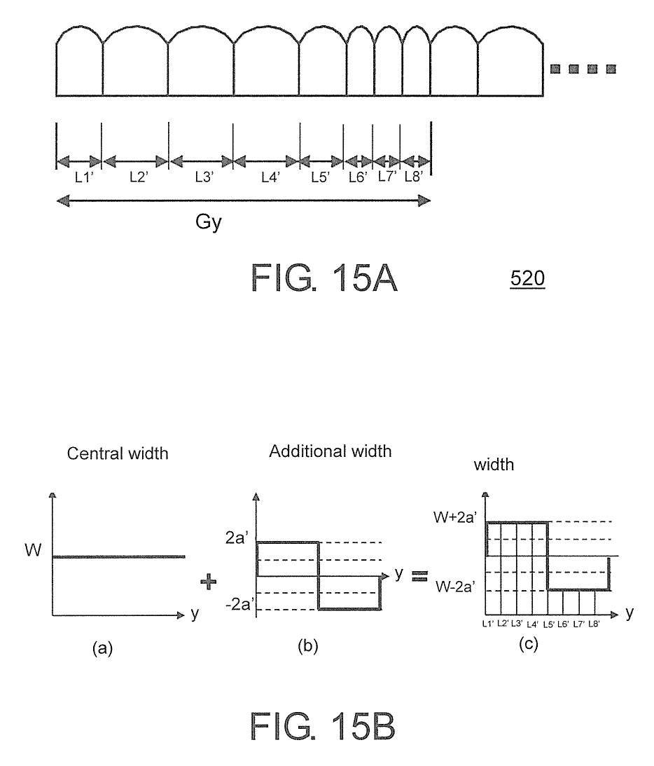

Furthermore, FIG. 15A is a schematic cross-sectional view along lines YY of directional light modulator shown in FIG. 13 according to the forth embodiment of the present invention, and FIG. 15B illustrates a relationship between a width and a position along Y direction of lenses in a constitutional group of FIG. 15A of a stereoscopic image display according to the fourth embodiment of the present invention. Referring to FIGS. 15A and 15B, in the directional light modulator 520 of this embodiment, take the width of the lens L1′ and that of the lens L5′ as central width W as shown in (a) of FIG. 15B, and a width of each lens related to the central width W in same sub-constitutional group Gy is defined as an additional width as shown in (b) of FIG. 15B. The amplitude of width vibration of lenses within the same constitutional group G is substantially 2a′, and the cycle within the same sub-constitutional group ranges from lens L1′ to lens L8′. As shown in (b) and (c) of FIG. 15B, the widths of the periodically changed structures, i.e. lenses, L1′ to L8′ in one sub-constitutional group Gy along the Y direction satisfy a function of square wave. Of course, the widths of the periodically changed structures, which are lenses arranged in array of one sub-constitutional group Gy along Y direction may satisfy other periodically functions like triangle wave or sine wave as mentioned in the foregoing embodiments.

Therefore, since directional light modulator of the present invention has multiple-width periodically changed lens array, the morie phenomenon can be effectively reduced while the viewer changes his viewing position, the principle is similar to the first embodiment and the second embodiment and thus not reiterated herein. It should be noted that since the periodically changed lenses in the lens array are periodically changing their widths, the bright region displayed by pixels and the dark region due to the black matrix of shifted pixels could be blurred. As a result, the total effective viewing frame keeps normal due to the widths of the lenses in the constitutional group G are periodically changed, so as to reduce the moiré phenomenon and thus providing an excellent stereo image for viewers.

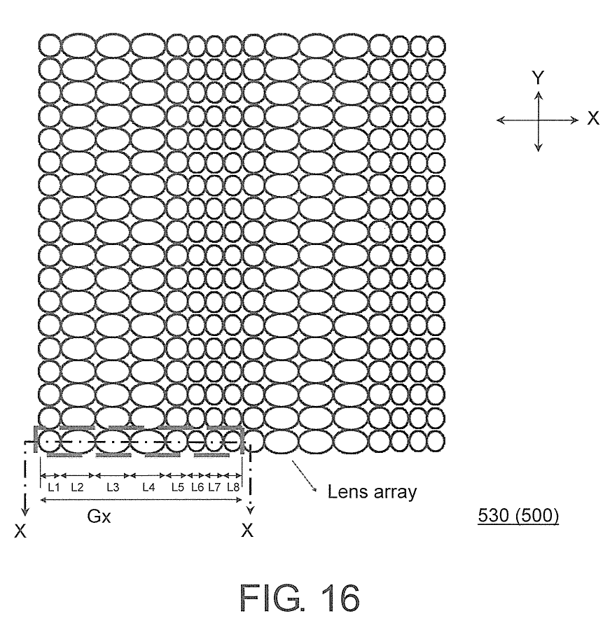

FIG. 16 is a schematic view of another directional light modulator in the stereoscopic image display according to the fourth embodiment of the present invention, wherein the directional light modulator 530 in this embodiment is similar to the directional light modulator 520 in the aforementioned embodiments except the directional light modulator 530 in this embodiment is merely changing the widths of lenses in sub-constitutional groups Gx, and the widths of lenses in sub-constitutional groups Gy are fixed.

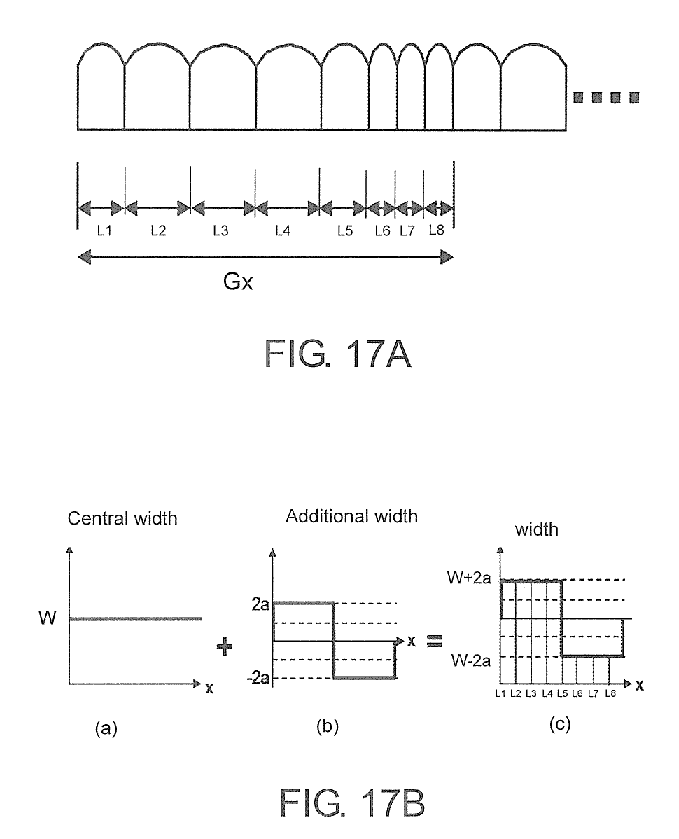

Moreover, FIG. 17A is a schematic cross-sectional view along lines XX of directional light modulator shown in FIG. 16 according to the fourth embodiment of the present invention, and FIG. 17B illustrates a relationship between a width and a position along X direction of lenses in a sub-constitutional group of FIG. 17A of a stereoscopic image display according to the fourth embodiment of the present invention. Referring to FIGS. 17A and 17B, in the directional light modulator 530 of this embodiment, the widths of the lens arranged in Y direction are fixed. As shown in FIG. 17B, take the width of the lens L1 and that of the lens L5 as central width Was shown in (a) of FIG. 17B, and a width of each lens related to the central width W in same sub-constitutional group Gx is defined as an additional width as shown in (b) of FIG. 17B. The amplitude of width vibration within the same sub-constitutional group Gx is substantially 2a, and the cycle within the same sub-constitutional group ranges from lens L1 to lens L8. As shown in (b) and (c) of FIG. 17B, the widths of the periodically changed structures, i.e. lenses, L1 to L8 in one sub-constitutional group Gx along the X direction satisfy a function of square wave. In other embodiments, the widths of the periodically changed structures, which are lenses arranged in array of one sub-constitutional group Gx along X direction may satisfy other periodically functions like triangle wave or sine wave as mentioned in the foregoing embodiments.

### Fifth Embodiment

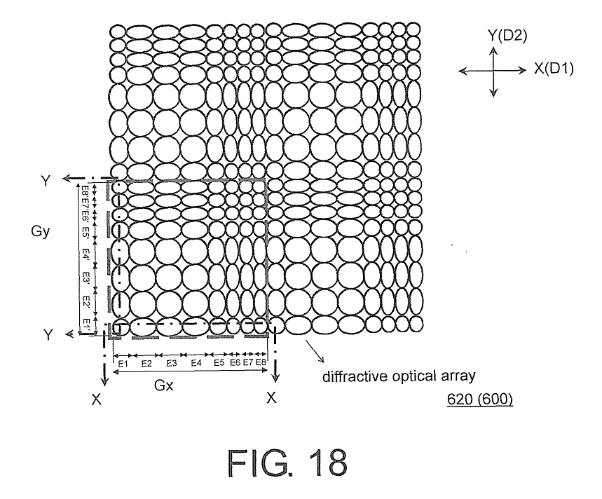

FIG. 18 is a schematic view of a directional light modulator in the stereoscopic image display according to the fifth embodiment of the present invention, wherein the principle of the stereoscopic image display 600 in fifth embodiment is similar to the stereoscopic image display 200, 300, 400, 500 in the aforementioned embodiments except the directional light modulator 620 is a diffractive optical array. More specifically, the directional light modulator 620 in this embodiment is a diffractive optical array, wherein the diffractive optical element has a plurality of constitutional groups G repeating arranged in X and Y directions, wherein each of constitutional groups G includes a plurality of periodically changed diffractive optical elements arranged in an array as the periodically changed structures. More specifically, each of the periodically diffractive optical elements in one constitutional groups G arranged in X direction is defined as sub-constitutional groups Gx, which includes periodically changed diffractive optical elements E1 to E8, and each of the periodically diffractive optical elements E1 to E8 in the same constitutional groups G arranged in Y direction is defined as sub-constitutional groups Gy, which includes periodically changed diffractive optical elements E1′ to E8′. As shown in FIG. 18, the periodically diffractive optical elements either in sub-constitutional groups Gx or sub-constitutional groups Gy may periodically changing its width along the X direction or Y direction of the constitutional groups G. In other words, the directional light modulator 620 in the present embodiment has multi-width periodically changed diffractive optical elements arranged in an array.

Furthermore, in consideration of improving the resolution in the horizontal direction, the repeating direction of the sub-constitutional groups Gx and the periodically diffractive optical elements E1 to E8 may also arranged as the stereoscopic image display as shown in FIG. 3C. On the other hand, the repeating direction of the sub-constitutional groups Gy and the periodically diffractive optical elements E1′ to E8′ therein may also arranged as the stereoscopic image display as shown in FIG. 3C, so as to improve the resolution in the vertical direction.

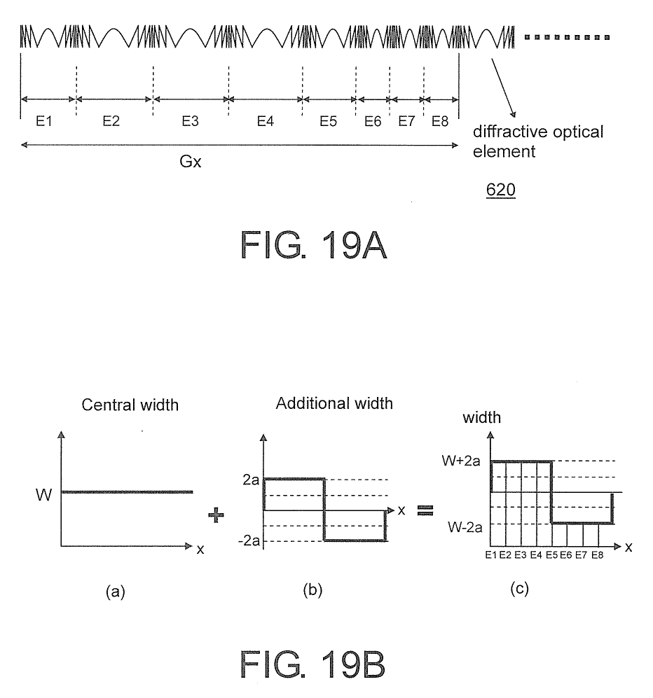

FIG. 19A is a schematic cross-sectional view along lines XX of directional light modulator shown in FIG. 18 according to the fifth embodiment of the present invention, and FIG. 19B illustrates a relationship between a width and a position along X direction of periodically changed structures in a constitutional group of FIG. 19A of a stereoscopic image display according to the fifth embodiment of the present invention. Referring to FIGS. 19A and 19B, in the directional light modulator 620 of this embodiment, take the width of the diffractive optical element E1 and that of the diffractive optical element E5 as central width W as shown in (a) of FIG. 19B, and a width of each diffractive optical element related to the central width W in same sub-constitutional group Gx is defined as an additional width as shown in (b) of FIG. 19B. The amplitude of width vibration of diffractive optical elements within the same constitutional group G is substantially 2a, and the cycle within the same sub-constitutional group ranges from diffractive optical element E1 to diffractive optical element E8. As shown in (b) and (c) of FIG. 19B, the widths of the periodically changed structures, i.e. diffractive optical elements, E1 to E8 in one sub-constitutional group Gx along the X direction satisfy a function of square wave, it may satisfy other periodically functions like triangle wave or sine wave as mentioned in the foregoing embodiments.

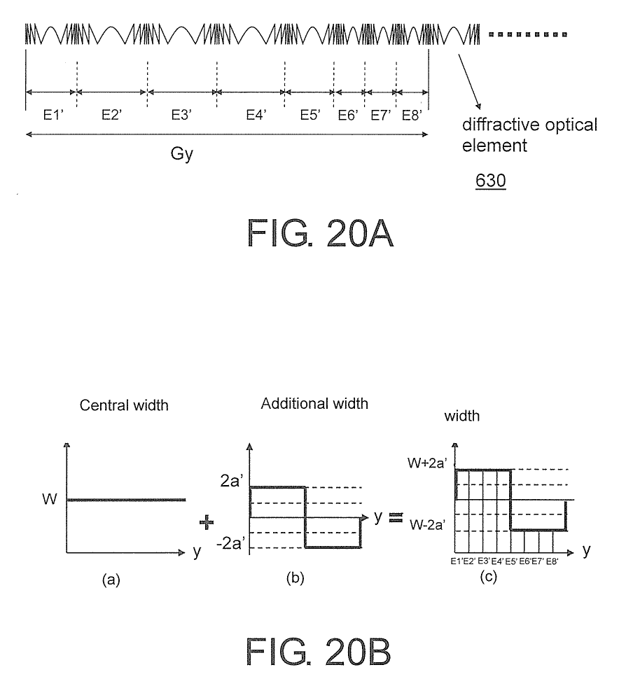

Furthermore, FIG. 20A is a schematic cross-sectional view along lines YY of directional light modulator shown in FIG. 18 according to the fifth embodiment of the present invention, and FIG. 20B illustrates a relationship between a width and a position along Y direction of periodically changed structures in a constitutional group of FIG. 20A of a stereoscopic image display according to the fifth embodiment of the present invention. Referring to FIGS. 20A and 20B, in the directional light modulator 630 of this embodiment, take the width of the diffractive optical element E1′ and that of the diffractive optical element E5′ as central width W as shown in (a) of FIG. 20B, and a width of each diffractive optical element related to the central width W in same sub-constitutional group Gy is defined as an additional width as shown in (b) of FIG. 20B. The amplitude of width vibration of diffractive optical elements within the same constitutional group G is substantially 2a′, and the cycle within the same sub-constitutional group ranges from diffractive optical element E1′ to diffractive optical element E8′. As shown in (b) and (c) of FIG. 20B, the widths of the periodically changed structures, i.e. diffractive optical elements, E1′ to E8′ in one sub-constitutional group Gy along the Y direction satisfy a function of square wave. Of course, it may satisfy other periodically functions like triangle wave or sine wave as mentioned in the foregoing embodiments.

Therefore, since the directional light modulator of the present invention has multiple-width periodically changed diffractive optical array, the morie phenomenon can be effectively reduced while the viewer changes his viewing position, the principle is similar to the foregoing embodiments and thus not reiterated herein. It should be noted that since the periodically changed diffractive optical elements in the diffractive optical array are periodically changing their sizes, the bright region displayed by pixels and the dark region due to the black matrix of shifted pixels could be blurred. As a result, the total effective viewing frame keeps normal due to the sizes of the diffractive optical elements in the constitutional group G are periodically changed, so as to reduce the moiré phenomenon and thus providing an excellent stereo image for viewers.

In the present embodiment, since directional light modulator of the present invention has multiple-width periodically diffractive optical elements, the moiré phenomenon can be effectively reduced while the viewer changes his viewing position, the principle is similar to the first embodiment and the second embodiment and thus not reiterated herein. It should be noted that since the periodically changed diffractive optical elements are periodically changing their widths, the bright region displayed by pixels and the dark region due to the black matrix of shifted pixels could be blurred. As a result, the total effective viewing frame keeps normal due to the widths of the diffractive optical elements in the constitutional group G are periodically changed, so as to reduce the moiré phenomenon and thus providing an excellent stereo image for the viewer.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A stereoscopic image display, comprising:
an image displaying unit having a pixel array; and
a directional light modulator disposed corresponding to the image displaying unit, wherein the directional light modulator comprises a plurality of constitutional groups repeating arranged in a first direction, each of constitutional groups comprises a plurality of periodically changed structures, and each periodically changed structure in same constitutional group changes its size along the first direction.

2. The stereoscopic image display as claimed in claim 1, wherein each of the periodically changed structures comprises a pattern and a slit, and a width of each pattern in the same constitutional group is periodically changed along the first direction.

3. The stereoscopic image display as claimed in claim 2, wherein the pitches of the slits within the same constitutional group are substantially the same.

4. The stereoscopic image display as claimed in claim 2, wherein a length extending direction of each slit is parallel to a column direction or a row direction of the pixel array.

5. The stereoscopic image display as claimed in claim 2, wherein a length extending direction of each slit is not parallel to a column direction or a row direction of the pixel array.

6. The stereoscopic image display as claimed in claim 2, wherein a variation of the widths of the periodically changed structures in the same constitutional group satisfies a function of triangle wave, square wave, or sine wave.

7. The stereoscopic image display as claimed in claim 1, wherein the periodically changed structures in same constitutional group are slits, and a pitch of each slit in the same constitutional group is periodically changed along the first direction.

8. The stereoscopic image display as claimed in claim 7, wherein each of constitutional groups comprises a plurality patterns with the same width, and each slit is disposed within one pattern.

9. The stereoscopic image display as claimed in claim 7, wherein a length extending direction of each slit is parallel to a column direction or a row direction of the pixel array.

10. The stereoscopic image display as claimed in claim 7, wherein a length extending direction of each slit is not parallel to a column direction or a row direction of the pixel array.

11. The stereoscopic image display as claimed in claim 7, wherein a variation of the pitches of slits in the same constitutional group satisfies a function of triangle wave, square wave, or sine wave.

12. The stereoscopic image display as claimed in claim 1, further comprising a backlight module, wherein the directional light modulator is disposed between the image displaying unit and the backlight module.

13. The stereoscopic image display as claimed in claim 1, further comprising a backlight module, wherein the image displaying unit is disposed between the directional light modulator and the backlight module.

14. The stereoscopic image display as claimed in claim 1, wherein each of the periodically changed structures comprises a lenticular lens, a width of each lens along in the same constitutional group is periodically changed along the first direction, and the directional light modulator is a lenticular screen.

15. The stereoscopic image display as claimed in claim 14, wherein a variation of the widths of lenses in the same constitutional group satisfies a function of triangle wave, square wave, or sine wave.

16. The stereoscopic image display as claimed in claim 1, wherein each of the periodically changed structures comprises a lens, and a width of each lens in the same constitutional group is merely periodically changed along the first direction.

17. The stereoscopic image display as claimed in claim 16, wherein a variation of the widths of lenses in the same constitutional group along the first direction satisfies a function of triangle wave, square wave, or sine wave.

18. The stereoscopic image display as claimed in claim 1, wherein each constitutional group comprises a plurality of a first sub-constitutional group repeating arranged in the first direction and a plurality of a second sub-constitutional group repeating arranged in a second direction.

19. The stereoscopic image display as claimed in claim 18, wherein each of the periodically changed structures comprises a lens, and a width of each lens in the same first sub-constitutional group is periodically changed along the first direction and a width of each lens in the same second sub-constitutional group is periodically changed along the second direction.

20. The stereoscopic image display as claimed in claim 19, wherein a variation of the widths of lenses either in the same first sub-constitutional group along the first direction or in the same second sub-constitutional group along the second direction satisfies a function of triangle wave, square wave, or sine wave.

21. The stereoscopic image display as claimed in claim 18, wherein each of the periodically changed structures comprises a diffractive optical element, and a width of each diffractive optical element in the same first sub-constitutional group is periodically changed along the first direction and a width of each diffractive optical element in the same second sub-constitutional group is periodically changed along the second direction.

22. The stereoscopic image display as claimed in claim 19, wherein a variation of the widths of diffractive optical elements either in the same first sub-constitutional group along the first direction or in the same second sub-constitutional group along the second direction satisfies a function of triangle wave, square wave, or sine wave.

23. The stereoscopic image display as claimed in claim 1, wherein the image displaying unit comprises a black matrix to define the pixel array.

24. The stereoscopic image display as claimed in claim 1, wherein the image displaying unit comprises a plurality of data lines and a plurality of scan lines intersecting with the data lines to define the pixel array.
